(19) United States
(12) Patent Application Publication
(10) Pub. No.: US 2024/0020684 A1
(43) Pub. Date: Jan. 18, 2024

(54) Multi-Factor Authentication (MFA) for Smart Contract Wallets

(71) Applicant: Zelus Wallet, LLC, Dallas, TX (US)

(72) Inventor: Kyle Thomas Mistele, Dallas, TX (US)

(21) Appl. No.: 18/222,995

(22) Filed: Jul. 17, 2023

Related U.S. Application Data
(60) Provisional application No. 63/389,737, filed on Jul. 15, 2022.

(51) Int. Cl. G06Q 20/36; G06Q 20/38; G06Q 20/40

(52) U.S. Cl. CPC G06Q 20/3674; G06Q 20/389; G06Q 20/3829; G06Q 20/405

(57) ABSTRACT

An MFA smart contract wallet provides security for blockchain transactions by enforcing MFA rules, for example a rule requiring that a user confirm a blockchain transaction by submitting separate requests containing the transaction's recipient, call data, and value to the MFA smart contract wallet from multiple different externally owned accounts, with each request being signed by a separate corresponding private key.

### CROSS-REFERENCE TO RELATED APPLICATION

The present application claims the benefit under 35 U.S.C. § 119(e) of U.S. Provisional Patent Application Ser. No. 63/389,737, entitled “Multi-Factor Authentication for Smart Contract Wallets,” filed on Jul. 15, 2022, and having the same assignee, the entire contents of which are incorporated herein by reference.

### TECHNICAL FIELD

This disclosure pertains generally to computer generated blockchains, and more specifically to enforcing MFA requirements for blockchain transactions utilizing multiple blockchain transaction requests from separate external resources for a single transaction.

### BACKGROUND

A conventional blockchain (e.g., Ethereum) transaction flow requires that the user specify certain fundamental properties of the transaction, such as the recipient, call data, value, and gas fee. Once the user has structured the transaction, they sign it using their private key. Once a transaction has been signed, the transaction can be sent by the user to a blockchain (e.g., the Ethereum network) for execution. However, the transaction could also be sent by an unauthorized third party that has obtained the user's private key.

A conventional multi-signature wallet 117 has multiple owners, and provides some protection against malicious actors because more than one approval from more than one owner of the wallet is required to initiate a blockchain transaction, making it more difficult for hackers to compromise individual users. In the prior art system 100 of FIG. 1, a multi-signature wallet 117 on device 115 submits a blockchain transaction request 125 upon receiving multiple approvals 127 from a given number of the multiple separate owners of the multi-signature wallet 117 (e.g., three approvals from three separate owners in the example illustrated in FIG. 1). This technique requires that multiple ones of the separate owners of the multi-signature wallet 117 submit signed approvals. In addition, compromise of the device 115 could also result in compromising the conventional multi-signature wallet 117.

It would be desirable address these issues.

### SUMMARY

A robust technique using a multi-factor (“MFA”) smart contract wallet with enhanced security is provided. The MFA smart contract wallet enforces MFA rules for blockchain transactions utilizing multiple blockchain transaction requests from separate external resources for a single transaction. The MFA smart contract wallet provides additional security, by requiring that a user confirm the transaction by submitting the transaction's recipient, call data, and value to the MFA smart contract wallet using multiple different externally owned accounts on multiple devices and/or applications. The enforcement of the MFA rules mitigates key compromise issues by preventing an attacker that has compromised less than a requisite number of the user's externally owned account (EOA) keys from spending smart contract wallet funds.

In one implementation, a proposed specific blockchain transaction request is transmitted to the MFA smart contract wallet from a proposing one of the user's externally owned accounts. The transmitted proposed specific blockchain transaction request is received by the MFA smart contract wallet. The proposed specific blockchain transaction request has a transaction value, call data and a recipient address, and has been signed by a unique private key associated with the proposing one of the user's externally owned accounts. The MFA smart contract wallet can include an MFA rule requiring a given number m of the externally owned accounts out of the total number n of externally owned accounts to each submit a blockchain transaction request to the MFA smart contract wallet, prior to execution of a corresponding single, specific blockchain transaction. In other words, the MFA smart contract wallet only executes an actual blockchain transaction when m of the n total externally owned accounts submit blockchain transaction requests including the requisite transaction information, with each blockchain transaction request from an externally owned account being signed by a unique private key associated with the corresponding externally owned account. In some implementations, m is at least two and n is equal to or greater than two. It is to be understood that m and n can have various values, e.g., m=3 and n=5, m=3 and n=3, m=4 and n=6, etc.

In one implementation, the MFA smart contract wallet receives responsive blockchain transaction requests from m minus l of the n total externally owned accounts, in support of the proposed specific blockchain transaction request. (Note that the MFA smart contract wallet has already received the proposed blockchain transaction request from one of the externally owned accounts, so to make a total of m received transaction requests, it now needs to receive m−1 more). The responsive blockchain transaction requests from the externally owned accounts each comprise the transaction value, the call data and the recipient address, each responsive transaction request being signed by a unique private key associated with a corresponding one of the externally owned accounts. In other implementations, more, less, or different transaction data can be used.

In some implementations, the MFA smart contract wallet notifies other ones of the n externally owned accounts that it has received the proposed blockchain transaction request, for example by utilizing a notification service to push out notifications concerning MFA smart contract wallet events.

In some implementations, responsive to satisfaction of the MFA rule requiring receipt of requests from a given number of the externally owned accounts, the MFA smart contract wallet transmits to the blockchain (e.g., executes) a multi-factor authenticated blockchain transaction request signed by its own unique private key, the multi-factor authenticated blockchain transaction request corresponding to the proposed specific blockchain transaction request.

The features and advantages described in this summary and in the following detailed description are not all-inclusive, and particularly, many additional features and advantages may be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 (prior art) is a block diagram illustrating a conventional multi-signature wallet.

FIG. 2 is a high-level block diagram illustrating a system enforcing MFA requirements for blockchain transactions utilizing multiple blockchain transaction requests from separate external resources for a single transaction, according to an implementation.

FIG. 3 is a more detailed block diagram illustrating a blockchain server for executing secured blockchain transactions by an MFA smart contract wallet using smart contract functionality, from the system of FIG. 2, according to an implementation.

FIG. 4 is a sequence diagram illustrating interactions by components of the system of FIG. 2, according to an implementation.

FIG. 5 is a high-level flow diagram illustrating a method for enforcing MFA requirements for blockchain transactions utilizing multiple blockchain transaction requests from separate external resources for a single transaction, according to an implementation.

FIG. 6 is a more detailed flow diagram illustrating a step of configuring secured blockchain transactions, from the method of FIG. 5, according to an implementation.

FIG. 7 is a more detailed flow diagram illustrating a step of executing secured blockchain transactions, from the method of FIG. 5, according to an implementation.

FIG. 8 is a block diagram of a general computing device for implementing components of the system of FIG. 2, according to an implementation.

The Figures depict various implementations for purposes of illustration only. One skilled in the art will readily recognize from the following discussion that other implementations of the structures and methods illustrated herein may be employed without departing from the principles described herein.

### DETAILED DESCRIPTION

The disclosure herein provides details of systems, methods, and non-transitory computer-readable media for enforcing MFA requirements for blockchain transactions utilizing multiple blockchain transaction requests from separate external resources for a single transaction. The implementations disclosed are limited for conciseness, however, those of the ordinary skill in the relevant art will recognize numerous additional implementations given the present disclosure.

I. Systems for MFA Smart Contract Wallets

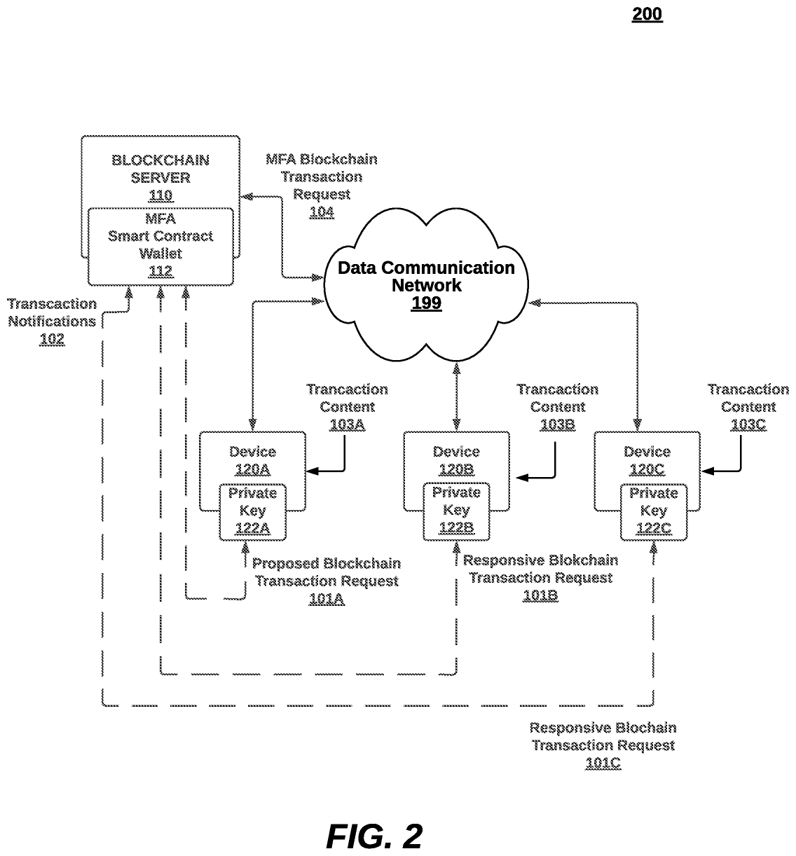

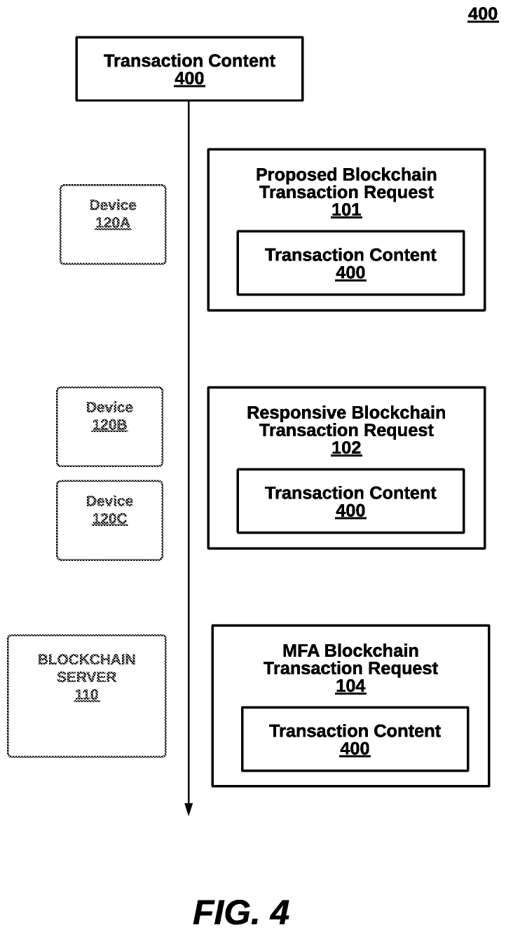

FIG. 2 is a block diagram illustrating a network environment of a system 200 for enforcing MFA requirements for blockchain transactions utilizing multiple blockchain transaction requests from separate external resources for a single transaction, according to some implementations. The system 200 includes a blockchain server 110 and devices 110A-C (three devices is just an example). The system 200 can have many variations, such more (or fewer) devices, distributed server components, and/or additional components, such as gateways, routers, and switches. The components can be implemented in hardware, software, or a combination, such as the example shown below in FIG. 4. In one implementation, a notification service is included for pushing notifications concerning MFA smart contract wallet 120 events to the devices and/or accounts. In another implementation, the MFA smart contract wallet 120 is located on a different server, at one of the devices 120A-C, or distributed between different computing devices as desired. In some implementations transactions can be conducted peer-to-peer without an intervening server.

The blockchain server 110 and devices 110A-C communicate via a data communication network 199 over wired and/or wireless media. The data communication network 199 can be composed of any data communication network such as the internet, an SDWAN, an SDN (Software Defined Network), a WAN, a LAN, a WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802.11r, 802.11be, Wi-Fi 6, Wi-Fi 6E, Wi-Fi 7 and the like. Components can use IPv4 or IPv6 address spaces. Various distributed components may act in coordination for blockchain transactions.

In one implementation, the MFA smart contract wallet 120 is located on the blockchain server 110 and manages associated transactions to the blockchain. A proposed transaction request is received and processed according to a smart contract instantiated as part of or in conjunction with the MFA smart contract wallet 120. The MFA smart contract wallet 120 includes MFA rules that dictate prerequisites for the transaction, such as how many authentications are required to authorize the transaction. For example, in different implementations independent authorization from 3 of 5 externally owned accounts (e.g., devices and/or applications) can be required, or 3 of 3, 2 of 5, etc. (these numbers are just examples). The smart contract's MFA rules can be static or conditional, such that different contexts may use different requirements, such as small cryptocurrency transfers versus large cryptocurrency transfers. The MFA rules can be set by various techniques. In one case, users configure rules (e.g., through a user interface) or rely on default rules and presets, provided by a software publisher or the like. In another case, MFA rules are derived from a smart contract on the blockchain of the proposed transaction. By applying smart contract MFA rules requirements outside of the blockchain itself, the MFA rules can be enforced prior to allowing execution of actual blockchain transactions.

Transaction approvals can be set for a single user or several different users, to represent a consensus of user accounts (e.g., devices and/or applications), or a consensus of users. Separate user devices protect against a hacked device, while separate users can protect against a rogue individual. The approval can be in the form of a blockchain transaction request which inherently identifies a source by including data from the requested transaction, such as transaction recipient, call data and/or value. Shorter (or longer) form approvals may also be implemented. One implementation notifies additional accounts of a pending approval, and can limit approvals based on time or other safety factors. Once smart contract wallet MFA rules are satisfied, the blockchain server 110 can issue its own transaction request to the blockchain to complete the process. This second level transaction may be transparent to the initiating device and approving devices which submit fully contained blockchain requests that could also complete the blockchain transaction, but for the smart contract wallet MFA rules.

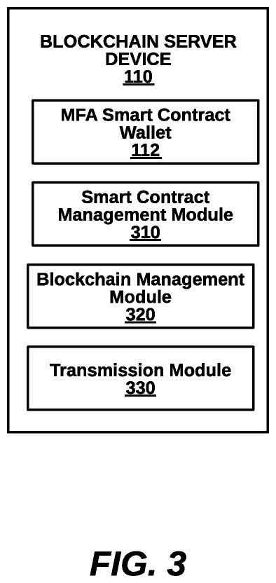

The blockchain server 110 can be instantiated as one or more physical and/or logical computing devices. Additionally, the blockchain server 110 can be for the private use of an owner's MFA smart contract wallet, or a third-party service provider hosting MFA smart contract wallets for multiple clients. More specific details of the blockchain server 110 are described below in association with FIG. 3.

The devices 120A-C can submit and jointly approve blockchain transactions from one or more users. Each of the devices 120A-C includes a corresponding private key 122A-C which may be kept in a wallet. As illustrated in FIG. 4, device 120A can initiate the process with a proposed blockchain transaction request 101 having transaction content 400 encrypted using that device's private key. In response, the devices 120B,120C each submit responsive blockchain transaction requests each having an instance of transaction content 400, encrypted with the separate private keys of those devices. Mismatched instances could stop the process due to potential compromise. The ultimate output of the MFA blockchain transaction request 104 from the MFA smart contract wallet 112 on the blockchain server 110 can be transparent to the devices 120A-C. In one implementation, the proposed blockchain transaction request 101 and the responsive blockchain transaction request 102 could each independently be executed to the blockchain, but for the MFA functionality enforced by the MFA smart contract wallet 112 on the blockchain server 110.

It is to be understood that a blockchain is a growing list of data records, known as blocks, which are linked together using cryptography. Each block contains a cryptographic hash of the previous block, and may contain a timestamp and transaction data. The timestamp proves that the transaction data existed when the block was added to the blockchain. As blocks in the chain each contain a cryptographic hash of the previous block, a blockchain is resistant to modification, because no block can be modified after it is added to the chain without altering all subsequent blocks. The nature of this cryptographic linking of the blocks provides a high level of security, especially if there are a large number of blocks.

A blockchain is distributed across a peer-to-peer network. Blockchains are managed by their corresponding peer-to-peer network, where nodes on the network collectively adhere to a given protocol to communicate and validate new blocks. A consensus algorithm is used that allows the participating nodes to agree on information included within each new block. Using the consensus algorithm, the blockchain is replicated and maintains the same state across the network of participants, allowing the blockchain to function as a secure, decentralized, append-only ledger. Examples of consensus algorithms that can be used in this capacity include proof-of-work, proof-of-stake, proof-of-activity, proof-of-burn, proof-of-capacity, or proof-of-elapsed time. Different blockchains utilize different formats, protocols, networks, etc. Some examples of blockchains include, Bitcoin, Ethereum, FLOW, Tezos, etc.

More generally, a blockchain can be used as a ledger for transactions using a specific corresponding digital currency (e.g., crypto currency), with the blocks documenting one or more transactions that involve the transfer of the corresponding currency from one party to another. In some implementations, the currency is created as a reward for a process called mining, which is successful use of the consensus protocol to solve a computational problem and thereby validate a new block that is added to the chain. This is known as a proof of work consensus protocol. In other implementations, different proof of consensus protocols are used, such as proof of stake in which nodes compete to append blocks and earn associated rewards in proportion to stake, or existing cryptocurrency allocated and locked or staked for some time period. Other consensus protocols include proof of authority, proof of space, proof of burn, or proof of elapsed time.

Digital currency is registered to a specific address (typically derived from a public key). Once created and awarded to a miner (or other party as appropriate in implementations using different consensus protocols), the currency can be transferred to another party, using the public key of the receiving party as an address and the private key of the transferring party to sign the transaction. Owners of units of digital currency can subsequently use it in further transactions. Each transaction is broadcast to the peer-to-peer network, and once validated it is added to a new block in the chain, created through the process of mining (or other method) using the consensus protocol. To prevent double spending, each transfer must refer to a previous unspent receipt of the currency in the blockchain.

One type of blockchain transaction is the purchase of a non-fungible token (NFT) using cryptocurrency. An NFT is a unit of data stored on a blockchain that certifies the unit of data to be unique and, therefore, not interchangeable. An NFT can be associated with a particular digital or physical asset (such as a file or a physical object), and a license to use the asset for a specified purpose. An NFT does not contain the underlying digital asset itself, but rather contains data that ties it to the asset. This data may be called the metadata. An example of metadata for an NFT would be a URL of a digital image to which the NFT grants rights. NFTs can be traded and sold on digital markets as blockchain transactions. Being a unit of data on a blockchain, an NFT may be sold and traded.

Unlike cryptocurrencies, NFTs are not mutually interchangeable, and hence are not fungible. While all bitcoins or ETH are equal, each NFT is unique, represents a different underlying asset, and thus may have a completely different value from other NFTs. When an NFT is created and added to a blockchain record, the process may be referred to as minting the NFT.

A smart contract may be in the form of a computer program or transaction protocol which may automatically execute, control or document relevant events and actions according to the terms of a contract or an agreement. A smart contract (the “mint”) may be created and placed on the blockchain. This contract may define the token type, structure, and in some cases code and data, and individuals can use the smart contract's functions to execute or complete blockchain transactions, to purchase an NFT (or multiple NFTs) defined by the contract, to transact them with other parties, and so forth. For instance, a smart contract can provide executables for the authentication and ownership transfer processes described herein.

Different blockchains use different standards and formats for representing NFTs and/or smart contracts. For example, a smart contract may be in the form of a program which is stored on and executed by the blockchain. A smart contract may be deployed to (stored on) the blockchain, and then users interact with the smart contract over the blockchain to complete transactions according to the terms of the smart contract. For example, a smart contract governing NFT-based transactions may define the token type, structure, and data/metadata of the NFT collection. A user interacting with such an NFT-based smart contract may cause execution of a mint function contained by the contract to create a new instance of an NFT in the collection defined by the contract. This mint function may be restricted so that only the creator of the smart contract can invoke it (thus creating a new NFT in the collection), or it may be unrestricted in which case any party may invoke this function.

A blockchain wallet is a software program, device or physical medium which stores a public/private key pair used for blockchain transactions. In addition to storing the keys, a cryptocurrency wallet may offer additional functionality such as encrypting and/or signing transactions using the private key. Various technologies can be used to store the values of the public and private keys, or a seed value for generating the keys, such as a software wallet running on a computer, a wallet hosted on an exchange where cryptocurrency is traded, wallet information on a digital medium, a dedicated hardware wallet, etc. An MFA smart contract wallet is a blockchain wallet further encompassing a smart contract for performing the MFA smart contract functionality described in more detail herein.

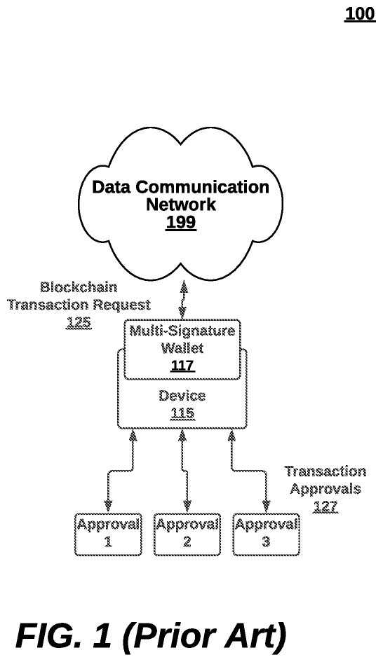

FIG. 3 is a block diagram illustrating components on blockchain server 110 of FIG. 1 in more detail, according to one implementation. In the illustrated implementation the blockchain server 110 includes the MFA smart contract wallet 112, a smart contract management module 310, a blockchain management module 320, and a transmission module 330. In some implementations, some or all of the smart contract management module 310, the blockchain management module 320, and/or the transmission module 330 are instantiated as part(s) of the MFA smart contract wallet 112. It is to be understood that although these components are illustrated in FIG. 3 as comprising separate entities, each illustrated component represents a collection of functionalities, which can be instantiated as a single or as multiple modules, as desired. In some implementations, the different modules and/or their functionalities can be distributed across different computing devices as desired.

In one implementation the blockchain management module may 320 execute transactions to the blockchain. For example, responsive to the above-described MFA rule being satisfied by receipt of blockchain transaction requests from m of the total externally owned accounts, wherein each blockchain transaction request from an externally owned account contains the transaction value, the call data and the recipient address, and is signed by a unique private key associated with the corresponding one of the externally owned accounts, the blockchain management module 320 can execute a corresponding transaction on the blockchain.

The smart contract management module 310 may configure the MFA smart contract wallet 112 and later detect or be notified of a proposed specific blockchain transaction request for routing to the MFA smart contract wallet 112 for authentication. Specific data for the transaction is contained in the secured request including a transaction value, call data and a recipient address, sent to an MFA smart contract wallet from a proposing one of the n externally owned accounts.

The MFA smart contract wallet 112 may comprise one or more MFA rules, for example an MFA rule specifying that an m number of externally owned account approvals out of an n total number of externally owned accounts are needed to approve blockchain transaction requests to the MFA smart contract wallet, prior to execution of a corresponding blockchain transaction. In some implementations, m is at least two and n is equal to or greater than two. Each transaction request is signed by a unique private key associated with a unique account (e.g., device or application). The MFA smart contract wallet 112 then submits a specific corresponding blockchain transaction request for execution on the specific blockchain, as an MFA smart contract wallet blockchain transaction request, signed by a unique private key of the MFA smart contract wallet.

The transmission module 330 may provide channel communication software and/or hardware for sending transaction requests and other data.

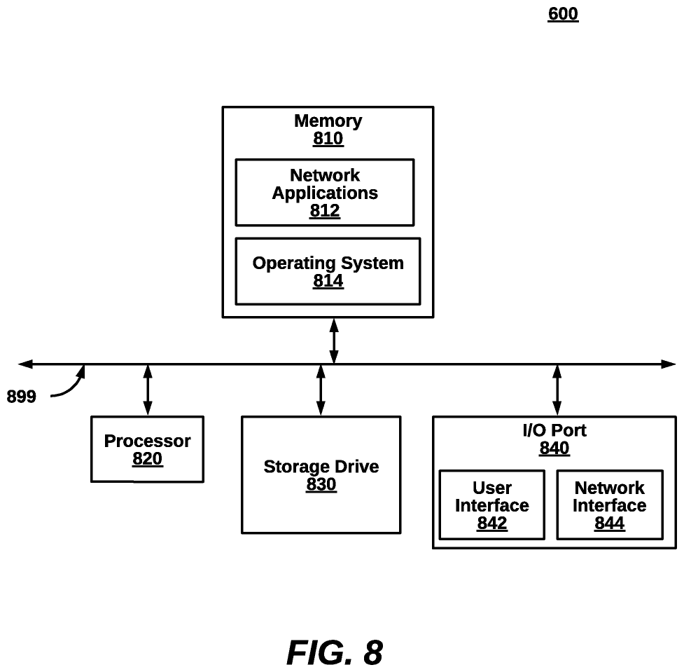

It is to be understood that the components and modules of the system 200 can be instantiated (for example as object code or executable images) within the system memory of a computing device as detailed in FIG. 8, such that when the processor 820 of the computer system 600 processes a module, the computer system 600 executes the associated functionality. As used herein, the terms “computer system,” “computer,” “backend computer system,” “endpoint computer system,” “client,” “client computer,” “server,” “server computer”, “computing device” and “computer device” mean one or more computers configured and/or programmed to execute the described functionality. Additionally, program code to implement the functionalities of system 200 can be stored on computer-readable storage media. Any form of tangible computer-readable storage medium can be used in this context, such as magnetic, optical, flash and/or solid-state storage media, or any other type of media. As used herein, the term “computer-readable storage medium” does not mean an electrical signal separate from an underlying physical medium.

II. Methods for MFA Smart Contract Wallets

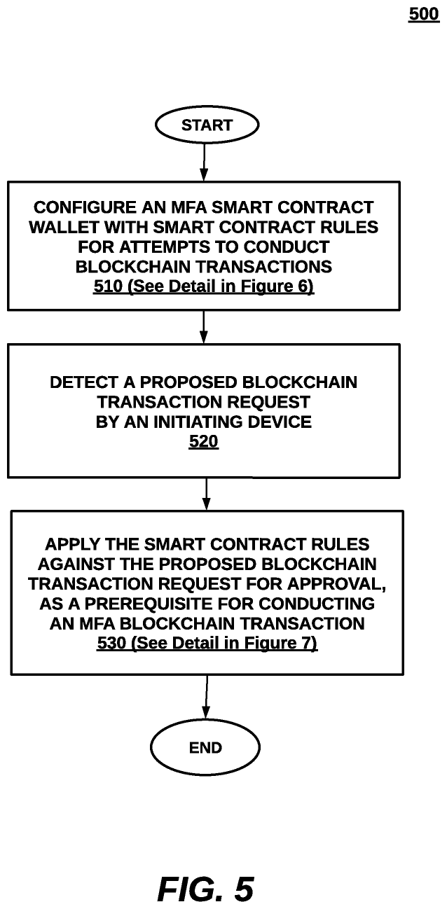

FIG. 5 is a high-level flow chart illustrating a method 500 for enforcing MFA requirements for blockchain transactions utilizing multiple blockchain transaction requests from separate external resources for a single transaction, according to one implementation. The listed steps are merely example groupings of functionality that can be performed in different orders. Many other variations are possible, for example as described in specific implementation examples that follow. In one implementation, the system 200 performs the steps of the method 500.

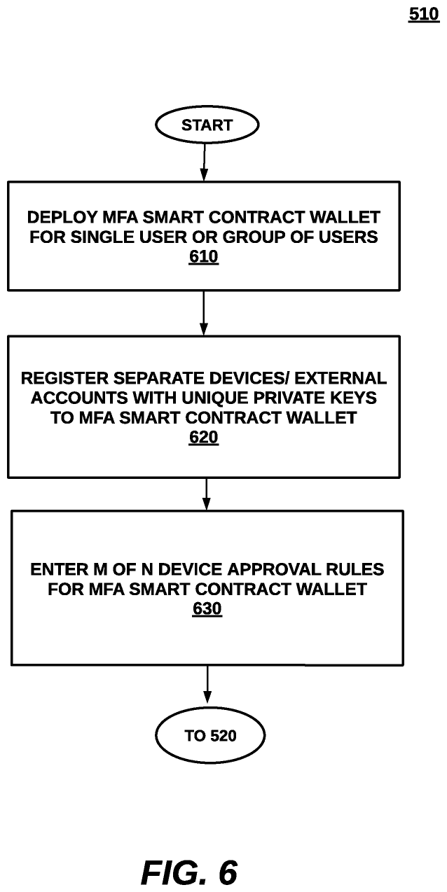

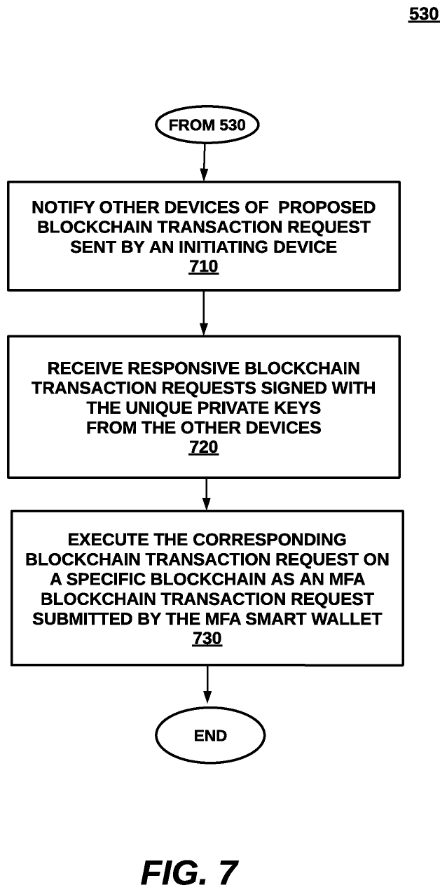

At step 510, an MFA smart contract wallet is configured with MFA rules, as detailed in FIG. 6. When a proposed blockchain transaction is detected, at step 520, then at step 530, MFA rules are deployed for executing the blockchain transaction, as detailed in FIG. 7.

Turning to step 610 of FIG. 6, an MFA smart contract wallet is deployed for a single user or group of users. Separate devices with unique private keys are registered to the MFA smart contract wallet, at step 620. The devices are governed at step 630 by specific MFA smart contract wallet rules.

Now referring to step 710 of FIG. 7, other accounts are notified of a proposed blockchain transaction request sent by an initiating account. It is understood that some implementations do not use notifications, for example under some circumstances when a single user initiates requests separately from each device using the same transaction content. Next, at step 720, responsive blockchain transaction requests are received from approving devices, each signed with a unique private key. In one implementation, more than one approval comes from a single device.

Ultimately, at step 730, a corresponding blockchain request is executed on the blockchain, as an MFA smart contract wallet blockchain transaction request.

In an example use case, let us imagine that a user Alice generates multiple Ethereum-compatible private keys (or keys for a different blockchain), and stores them on different devices. These can be considered as K1 . . . Kn with addresses A1 . . . An where n≥2. In this scenario, there would be a minimum of two private keys and two devices, however Alice could use one or more additional private keys and/or one or more devices. Additionally, she could use multiple private keys on a single device.

For the sake of example, we will imagine that Alice creates two keys: one on her laptop, and one on a mobile smartphone. The key on Alice's laptop will be called K1 with address A1, and the key on her phone will be called K2 with address A2. Furthermore, the key K2 on Alice's phone may optionally be stored in an application which is designed for this multi-factor authentication scheme. This application implements or consumes a service which is capable of listening to events on the blockchain, and can notify or prompt the user (Alice) when certain events are emitted from a smart contract. This notification service may be implemented on Alice's device, or it may be implemented as a cloud-based software service. The service does not have either of Alice's keys, but it can be configured with an address to which it should subscribe for emitted events. In this case, the service would subscribe to events emitted from the multi-factor authentication smart contract wallet.

Note that this notification service is optional, but it can significantly enhance the system's usability and user experience. Consider the following specifications to the MFA wallet smart contract, which will be helpful for the notification service: a) an event is emitted from the smart contract when a transaction is proposed; b) an event is emitted from the smart contract when a signatory approves a proposed transaction.

From here, Alice can use K1 (or, technically, any of the other keys) to deploy the MFA smart contract to the blockchain, and she can pass it the addresses A1 . . . An, of the n accounts, as well as specify the number of these m accounts that must approve a proposed transaction before it is executed. Alice can then use the contract's address to receive funds and other digital assets as she would a normal externally owned account. Alice can then configure the notification service with the address of the MFA smart contract wallet so that it knows which contract to listen for events on.

When Alice wishes to send funds from the MFA smart contract wallet, she can generate a transaction and then use one of keys K1 . . . Kn to propose it by submitting the transaction data to the MFA smart contract wallet using one of the schemes described above. Proposing a transaction on the MFA smart contract wallet would cause an event to be emitted from the smart contract (per the assumptions above). The notification service would receive this event, and could send out a push notification (or multiple notifications, if there are >2 devices involved in the scheme) to the additional devices which have signatory keys, notifying them that a new transaction was proposed which they can approve. Alice can then use the application which contains the key on each device to approve or reject the transaction using one of the schemes detailed above. Once the requisite number of approvals is reached, the transaction will be executed by the MFA smart contract wallet.

Continuing with the example use case, now let us consider some malicious actor called “Eve.” Eve wants to compromise the funds in Alice's MFA smart contract wallet. Eve manages to compromise one of Alice's devices, and is able to recover one or more of the signing keys K1 . . . Ki. As long as the number of keys that Eve compromises is less than m, the number of signatories that must approve a transaction for the MFA smart contract wallet to be executed, then she cannot access the funds which are stored in the MFA smart contract wallet.

In our example m=n=2. Eve must compromise both devices/keys to successfully execute a transaction on Alice's behalf. We can however imagine a scenario where Alice deploys a 3-of-5 multi-factor authentication smart contract wallet. Eve would need to compromise 3 of the 5 keys in order to compromise the funds in the wallet. For a scenario like a 5-of-5, Eve must compromise 5 devices to access the funds in the MFA smart contract wallet. The number m of requisite signatories should be determined based on what tradeoff Alice is willing to make between usability and security. A 5-of-5 MFA smart contract wallet is highly secure, but is very inconvenient as she must approve any transaction from all 5 devices or applications. A 2-of-2 is less secure (though still more secure than using a normal EOA without a multi-factor authentication smart contract wallet), but is much more convenient.

III. Computer Devices for MFA Smart Contract Systems

FIG. 8 is a block diagram of an example computer device 800 suitable for implementing components of blockchain authentication in the system 200 of FIG. 2, according to an implementation. For example, the blockchain server 110 and the devices 120A-C can be embodied on one or more computing device(s) 800, in the form of a rack-based computer, a desktop computer, a laptop computer, a tablet computer, a smartphone, a server blade, and the like. As illustrated, the computer device 800 includes a memory 810, a processor 820, a storage drive 830 and an I/O port 840, each communicatively coupled by a bus 899.

The memory 810 further comprises network access applications 812 and an operating system 814. Network access applications 812 can include a web browser, a mobile access application, an access application that uses networking, a remote access application executing locally, a network protocol access application, a network management access application, a network routing access applications, or the like.

The operating system 814 can be one of the Microsoft Windows® family of operating systems (e.g., Windows NT, Windows 7-11, Windows Vista, Windows CE, Windows Mobile, etc.), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 820 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 820 can be single core, multiple core, or include more than one processing element. The processor 820 can be disposed on silicon or any other suitable material. The processor 820 can receive and execute instructions and data stored in the memory 810 or the hard drive 830.

The storage device 830 can be any non-volatile type of storage such as a magnetic disc, EEPROM, Flash, or the like. The storage device 830 stores code and data for access applications.

The I/O port 840 further comprises a user interface 842 and a network interface 844. The user interface 842 can output to a display device and receive input from, for example, a keyboard. The network interface 844 connects to a medium such as Ethernet or Wi-Fi for data input and output. In one implementation, the network interface 844 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be instantiated as one or more processes with one or more entry points, with data input and optionally a data display module. The computer software product may be instantiated as classes that define distributed objects. The computer software products may also be in the form of component software such as Java Beans or Enterprise Java Beans.

Furthermore, the computer that is running the previously mentioned computer software may be connected to a network and may interface to other computers using this network. The network may be on an intranet or the internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an implementation, with a Web browser executing on a computer workstation system, a user accesses a system on the World Wide Web (WWW) through a network such as the internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

As will be understood by those familiar with the art, the subject matter described herein may be embodied in other specific forms without departing from the spirit or integral characteristics thereof. Likewise, the particular naming and division of the portions, modules, agents, managers, components, functions, procedures, actions, layers, features, attributes, methodologies, data structures and other aspects are not mandatory or significant, and the entities used that implement the subject matter described herein may have different names, divisions and/or formats. The foregoing description, for the purpose of explanation, has been described with reference to specific implementations. However, the illustrative discussions above are not intended to be exhaustive or limiting to the precise forms disclosed. Many modifications and variations are possible in view of the above teachings. The implementations were chosen and described in order to best explain relevant principles and their practical applications, to thereby enable others skilled in the art to best utilize various implementations with or without various modifications as may be suited to the particular use contemplated.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic device, that manipulates and transforms data represented as physical (electronic) quantities within the computer system's registers and memories into other data similarly represented as physical quantities within the computer system memories or registers or other such information storage, transmission or display devices.

Finally, the structure, algorithms, and/or interfaces presented herein are not inherently tied to any particular computer or other apparatus. Various general-purpose systems may be used with programs in accordance with the teachings herein, or it may prove convenient to construct more specialized apparatus to perform the method blocks. The structure for a variety of these systems will appear from the description above. In addition, the specification is not described with reference to any particular programming language. It will be appreciated that a variety of programming languages may be used to implement the teachings of the specification as described herein.

Accordingly, the disclosure is intended to be illustrative, but not limiting.

What is claimed is:

1. A computer-implemented method executed by a multi-factor authentication (MFA) smart contract wallet for securing blockchain transactions, by enforcing MFA rules requiring a number m of separate blockchain transaction requests from separate ones of a plurality consisting of a number n total externally owned accounts to authorize a corresponding single, specific blockchain transaction, the method comprising:
receiving, by the MFA smart contract wallet, from a proposing one of the n externally owned accounts, a proposed specific blockchain transaction request having a transaction value, call data and a recipient address, and being signed by a unique private key associated with the proposing one of the n externally owned accounts;
wherein the MFA smart contract wallet includes an MFA rule requiring the number m externally owned accounts out of the number n total externally owned accounts to each submit a blockchain transaction request to the MFA smart contract wallet, prior to execution of a corresponding single, specific blockchain transaction, wherein m is at least two and n is equal to or greater than two, and wherein each blockchain transaction request from an externally owned account is signed by a unique private key associated with the corresponding externally owned account;
receiving, by the MFA smart contract wallet, responsive blockchain transaction requests from the number m minus l of the number n total externally owned accounts, in support of the proposed specific blockchain transaction request, wherein the responsive blockchain transaction requests from the externally owned accounts each comprise the transaction value, the call data and the recipient address, each responsive transaction request being signed by a unique private key associated with a corresponding one of the externally owned accounts; and
executing, responsive to satisfaction of the MFA rule, a multi-factor authenticated blockchain transaction request signed by a unique private key of the MFA smart contract wallet, the multi-factor authenticated blockchain transaction request corresponding to the proposed specific blockchain transaction request.

2. The method of claim 1, wherein the transaction value, the call data and the recipient address are received at a device or an application corresponding to each one the one of the n externally owned accounts, prior to submitting the responsive blockchain transaction requests from the m approving ones of the externally owned accounts.

3. The method of claim 1, further comprising notifying other of the n externally owned accounts of the proposed blockchain transaction request received by the MFA smart contract wallet.

4. The method of claim 1, using a notification service to push notifications to each one of the n externally owned accounts, the pushed notifications concerning MFA smart contract wallet events, the events including proposed blockchain transaction requests received by the MFA smart contract wallet.

5. The method of claim 1, wherein there is a fixed period of time for the m approving ones of the externally owned accounts to submit the responsive blockchain transaction requests.

6. The method of claim 1, wherein the n total number of external accounts each having a unique private key are controlled by a single user.

7. The method of claim 1, wherein the n total number of external accounts each having a unique private key are controlled by a plurality of different users.

8. The method of claim 1, wherein the n total number of unique private keys are associated with externally owned accounts on different computing devices.

9. The method of claim 1, wherein the n total number of unique private keys are associated with different applications on one or more computing devices.

10. The method of claim 1, wherein the proposed blockchain transaction comprises sending cryptocurrency from the MFA smart contract wallet to a receiving wallet.

11. The method of claim 1, wherein at least one externally owned account comprises an application associated with at least a private key.

12. The method of claim 1, wherein at least one externally owned account comprises a wallet comprising at least a private key.

13. The method of claim 1, wherein the blockchain server is located remotely from the externally owned accounts.

14. The method of claim 1, wherein each externally owned account is hosted by a unique computing device.

15. At least one non-transitory computer-readable storage medium for securing blockchain transactions, by enforcing MFA rules requiring a number m of separate blockchain transaction requests from separate ones of a plurality consisting of a number n total externally owned accounts to authorize a corresponding single, specific blockchain transaction, the at least one non-transitory computer-readable storage medium storing computer executable instructions that, when loaded into computer memory and executed by at least one processor of a computing device, cause the computing device to perform the following steps:
receiving, by an MFA smart contract wallet, from a proposing one of the n externally owned accounts, a proposed specific blockchain transaction request having a transaction value, call data and a recipient address, and being signed by a unique private key associated with the proposing one of the n externally owned accounts;
wherein the MFA smart contract wallet includes an MFA rule requiring the number m externally owned accounts out of the number n total externally owned accounts to each submit a blockchain transaction request to the MFA smart contract wallet, prior to execution of a corresponding single, specific blockchain transaction, wherein m is at least two and n is equal to or greater than two, and wherein each blockchain transaction request from an externally owned account is signed by a unique private key associated with the corresponding externally owned account;
receiving, by the MFA smart contract wallet, responsive blockchain transaction requests from the number m minus 1 of the number n total externally owned accounts, in support of the proposed specific blockchain transaction request, wherein the responsive blockchain transaction requests from the externally owned accounts each comprise the transaction value, the call data and the recipient address, each responsive transaction request being signed by a unique private key associated with a corresponding one of the externally owned accounts; and
executing, responsive to satisfaction of the MFA rule, a multi-factor authenticated blockchain transaction request signed by a unique private key of the MFA smart contract wallet, the multi-factor authenticated blockchain transaction request corresponding to the proposed specific blockchain transaction request.

16. The at least one non-transitory computer-readable storage medium of claim 15, wherein the transaction value, the call data and the recipient address are received at a device or an application corresponding to each one the one of the n externally owned accounts, prior to submitting the responsive blockchain transaction requests from the m approving ones of the externally owned accounts.

17. The at least one non-transitory computer-readable storage medium of claim 15, further comprising notifying other of the n externally owned accounts of the proposed blockchain transaction request received by the MFA smart contract wallet.

18. The at least one non-transitory computer-readable storage medium of claim 15, using a notification service to push notifications to each one of the n externally owned accounts, the pushed notifications concerning MFA smart contract wallet events, the events including proposed blockchain transaction requests received by the MFA smart contract wallet.

19. The at least one non-transitory computer-readable storage medium of claim 15, wherein there is a fixed period of time for the m approving ones of the externally owned accounts to submit the responsive blockchain transaction requests.

20. The at least one non-transitory computer-readable storage medium of claim 15, wherein the n total number of external accounts each having a unique private key are controlled by a single user.

21. The at least one non-transitory computer-readable storage medium of claim 15, wherein the n total number of external accounts each having a unique private key are controlled by a plurality of different users.

22. The at least one non-transitory computer-readable storage medium of claim 15, wherein the n total number of unique private keys are associated with externally owned accounts on different computing devices.

23. The at least one non-transitory computer-readable storage medium of claim 15, wherein the n total number of unique private keys are associated with different applications on one or more computing devices.

24. The at least one non-transitory computer-readable storage medium of claim 15, wherein the proposed blockchain transaction comprises sending cryptocurrency from the MFA smart contract wallet to a receiving wallet.

25. The at least one non-transitory computer-readable storage medium of claim 15, wherein at least one externally owned account comprises an application associated with at least a private key.

26. The at least one non-transitory computer-readable storage medium of claim 15, wherein at least one externally owned account comprises a wallet comprising at least a private key.

27. The at least one non-transitory computer-readable storage medium of claim 15, wherein the blockchain server is located remotely from the externally owned accounts.

28. The at least one non-transitory computer-readable storage medium of claim 15, wherein each externally owned account is hosted by a unique computing device.

29. A computer system for securing blockchain transactions, by enforcing MFA rules requiring a number m of separate blockchain transaction requests from separate ones of a plurality consisting of a number n total externally owned accounts to authorize a corresponding single, specific blockchain transaction, the computer system comprising:
at least one processor;
a network interface, communicatively coupled to the at least one processor and to an external data communication network;
a memory, communicatively coupled to the at least one processor;
an MFA smart contract wallet residing in the memory and comprising:
a proposed specific blockchain transaction request receiving module configured to receive, from a proposing one of the n externally owned accounts, a proposed specific blockchain transaction request having a transaction value, call data and a recipient address, and being signed by a unique private key associated with the proposing one of the n externally owned accounts;
wherein the MFA smart contract wallet includes an MFA rule requiring the number m externally owned accounts out of the number n total externally owned accounts to each submit a blockchain transaction request to the MFA smart contract wallet, prior to execution of a corresponding single, specific blockchain transaction, wherein m is at least two and n is equal to or greater than two, and wherein each blockchain transaction request from an externally owned account is signed by a unique private key associated with the corresponding externally owned account;
a responsive blockchain transaction requests receiving module configured to receive responsive blockchain transaction requests from the number m minus l of the number n total externally owned accounts, in support of the proposed specific blockchain transaction request, wherein the responsive blockchain transaction requests from the externally owned accounts each comprise the transaction value, the call data and the recipient address, each responsive transaction request being signed by a unique private key associated with a corresponding one of the externally owned accounts; and
a multi-factor authenticated blockchain transaction request executing module configured to execute, responsive to satisfaction of the MFA rule, a multi-factor authenticated blockchain transaction request signed by a unique private key of the MFA smart contract wallet, the multi-factor authenticated blockchain transaction request corresponding to the proposed specific blockchain transaction request.
